(19) United States
(12) Patent Application Publication
(10) Pub. No.: US 2016/0327242 A1
(43) Pub. Date: Nov. 10, 2016

(54) COMPACT LED MODULE

(71) Applicant: LUSTROUS TECHNOLOGY LTD., New Taipei City (TW)

(72) Inventors: Kao-Hsu CHOU, New Taipei City (TW); Juei-Khai LIU, New Taipei City (TW); Chia-Chi LIU, New Taipei City (TW)

(73) Assignee: LUSTROUS TECHNOLOGY LTD., New Taipei City (TW)

(21) Appl. No.: 14/799,383

(22) Filed: Jul. 14, 2015

(30) Foreign Application Priority Data
May 7, 2015 (TW) 104206938

(51) Int. Cl. F21V 7/04; F21V 29/89; F21V 17/06; F21V 23/00

(52) U.S. Cl. CPC F21V 7/04; F21V 23/006; F21V 29/89; F21V 17/06; F21Y 2101/02

(57) ABSTRACT

A compact LED module includes: a circuit substrate, formed with an opening, a pair of combination holes and at least one through via area formed with a plurality of through vias; a reflection cup, formed with a light inlet, a light outlet and a pair of combination posts, wherein the pair of combination posts are combined with the pair of combination holes for allowing the reflection cup to be fastened on a first surface of the circuit substrate, and the light inlet is aligned with the opening; and a LED unit, installed with a LED light source and formed with at least one soldering area, wherein each of the soldering areas is connected to each of the through via areas by utilizing solder, thereby allowing the LED unit to be fastened on a second surface of the circuit substrate, and the LED light source is aligned with the opening.

### BACKGROUND OF THE INVENTION

1. Field of the Invention

The present invention relates to a LED (light emitting diode) module, especially to a compact LED module.

2. Description of Related Art

A conventional LED module is installed with a drive circuit inside its housing for driving a LED unit. In addition, one surface of the housing is formed with a reflection cup accommodating recess for being engaged with a reflection cup.

However, electronic components contained in the drive circuit would force the depth of the reflection cup accommodating recess of the LED module to be increased, so a reflection cup having a relatively larger size is unable to be combined with the LED module because a mechanical interference is generated between the reflection cup and the reflection cup accommodating recess.

Accordingly, a novel LED module shall be developed by the skilled people in the art for solving the above-mentioned shortage.

### SUMMARY OF THE INVENTION

One primary objective of the present invention is to provide a compact LED module, in which a compact assembling structure is adopted, so a mechanical interference caused by a reflection cup can be avoided and the assembly procedure can also be simplified.

Another objective of the present invention is to provide a compact LED module, in which a plurality of combination holes are formed on a circuit substrate, so reflection cups in various sizes can be supported.

For achieving said objectives, the present invention provides a compact LED module, which includes:

a circuit substrate, formed with an opening, a pair of combination holes and at least one through via area, wherein the pair of combination holes oppose each other across the opening and each of the through via area is formed with a plurality of through vias;

a reflection cup, formed with a light inlet, a light outlet and a pair of combination posts, wherein the pair of combination posts oppose each other across the light inlet and combined with the pair of combination holes of the circuit substrate, thereby allowing the reflection cup to be fastened on a first surface of the circuit substrate, and the light inlet is aligned with the opening of the circuit substrate; and

a LED unit, installed with a LED light source and formed with at least one soldering area, wherein each of the soldering areas is connected to each of the through via areas of the circuit substrate by utilizing solder, thereby allowing the LED unit to be fastened on a second surface of the circuit substrate, and the LED light source is aligned with the opening of the circuit substrate.

According one embodiment of the present invention, in the compact LED module, an adhesive layer is further provided between the reflection cup and the circuit substrate for fastening the reflection cup on the first surface of the circuit substrate.

According one embodiment of the present invention, the circuit substrate is installed with a drive circuit.

According one embodiment of the present invention, the circuit substrate is made of an aluminum substrate.

According one embodiment of the present invention, the LED light source of the LED unit includes at least one LED chip for providing a white light or a non-white light.

According one embodiment of the present invention, the LED unit is a DC LED unit.

According one embodiment of the present invention, the LED unit is an AC LED unit.

For achieving said objectives, the present invention provides a compact LED module, which includes:

a circuit substrate, formed with an opening, plural pairs of combination holes and a plurality of through via areas, wherein each pair of the plural pairs of combination holes oppose each other across the opening and have a different distance therebetween, and each of the through via areas is formed with a plurality of through vias;

a reflection cup, formed with a light inlet, a light outlet and a pair of combination posts, wherein the pair of combination posts oppose each other across the light inlet and combined with one pair of the plural pairs of combination holes of the circuit substrate, thereby allowing the reflection cup to be fastened on a first surface of the circuit substrate, and the light inlet is aligned with the opening of the circuit substrate; and

a LED unit, installed with a LED light source and formed with a plurality of soldering areas, wherein each of the soldering areas is connected to each of the through via areas of the circuit substrate by utilizing solder, thereby allowing the LED unit to be fastened on a second surface of the circuit substrate, and the LED light source is aligned with the opening of the circuit substrate.

According one embodiment of the present invention, the LED light source of the LED unit includes at least one LED chip for providing a white light or a non-white light.

According one embodiment of the present invention, the LED unit is a DC LED unit.

According one embodiment of the present invention, the LED unit is an AC LED unit.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view illustrating the compact LED module according to one embodiment of the present invention;

FIG. 2 is a schematic view illustrating the appearance of the assembled compact LED module of FIG. 1 according to one embodiment of the present invention;

FIG. 3 is another schematic view illustrating the appearance of the assembled compact LED module of FIG. 1 according to one embodiment of the present invention;

FIG. 4 is a cross sectional view illustrating the assembled compact LED module of FIG. 1 according to one embodiment of the present invention;

FIG. 5 is an exploded view illustrating the compact LED module according to another embodiment of the present invention; and

FIG. 6 is a schematic view illustrating the assembly of the compact LED module of FIG. 5 according to another embodiment of the present invention.

### DETAILED DESCRIPTION OF THE PREFERRED EMBODIMENT

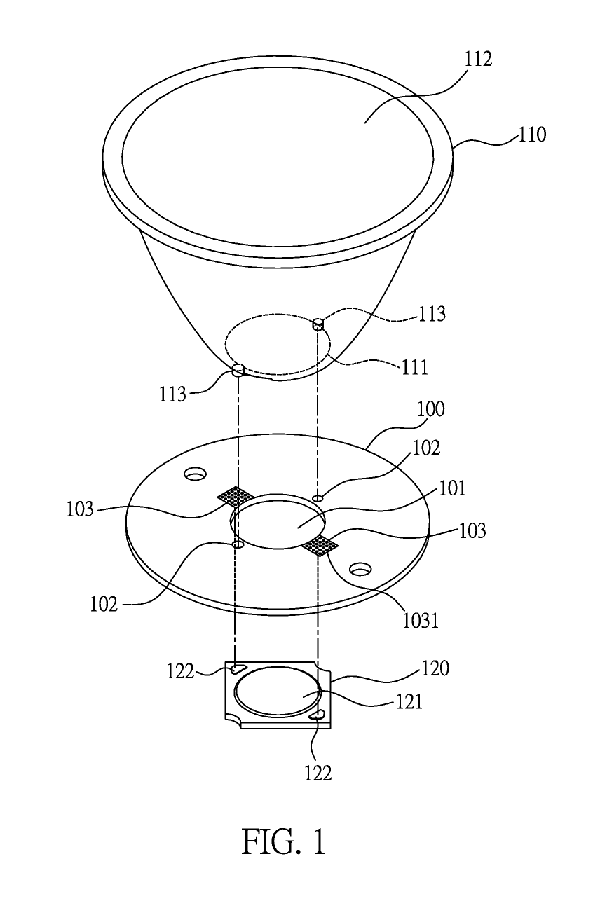

Please refer to FIG. 1, which is an exploded view illustrating the compact LED module according to one embodiment of the present invention. As shown in FIG. 1, the compact LED module includes a circuit substrate 100, a reflection cup 110 and a LED unit 120.

The circuit substrate 100 is made of an aluminum substrate for providing a heat dissipating function, and formed with an opening 101, a pair of combination holes 102 and two through via areas 103, wherein the pair of combination holes 102 oppose each other across the opening 101, and the through via areas 103 are formed with a plurality of through vias 1031. In addition, the circuit substrate 100 is installed with a drive circuit (not shown in figures) for driving a DC (direction current) LED load or an AC (alternating current) LED load.

The reflection cup 110 is formed with a light inlet 111, a light outlet 112 and a pair of combination posts 113, wherein the pair of combination posts 113 oppose each other across the light inlet 111 and capable of being combined with the pair of combination holes 102 of the circuit substrate 100 for allowing the reflection cup 110 to be fastened on a first surface of the circuit substrate 100, and the light inlet 111 is aligned with the opening 101 of the circuit substrate 100.

The LED unit 120 is installed with a LED light source 121 and formed with two soldering areas 122, wherein the two soldering areas 122 are connected to the two through via areas 103 of the circuit substrate 100 by utilizing solder thereby allowing the LED unit 120 to be fastened on a second surface of the circuit substrate 100, and the LED light source 121 is aligned with the opening 101 of the circuit substrate 100. The LED light source 121 of the LED unit 120 includes at least one LED chip for providing a white light or a non-white light, and the LED unit 120 can be a DC LED unit or an AC LED unit.

In addition, an adhesive layer can be provided between the reflection cup 110 and the circuit substrate 100 for assisting the reflection cup 110 being fastened on the first surface of the circuit substrate 100.

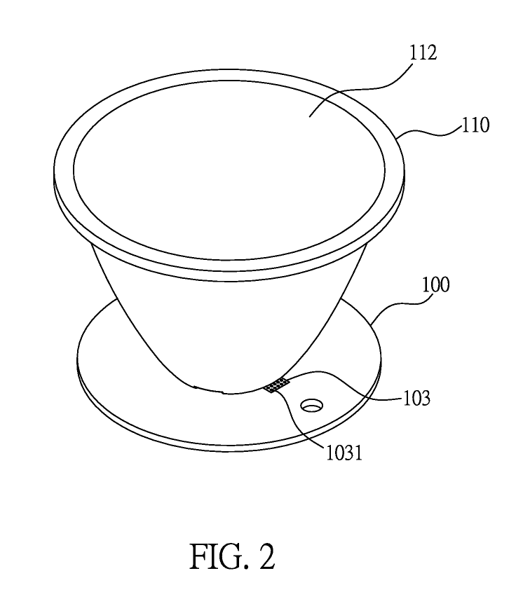

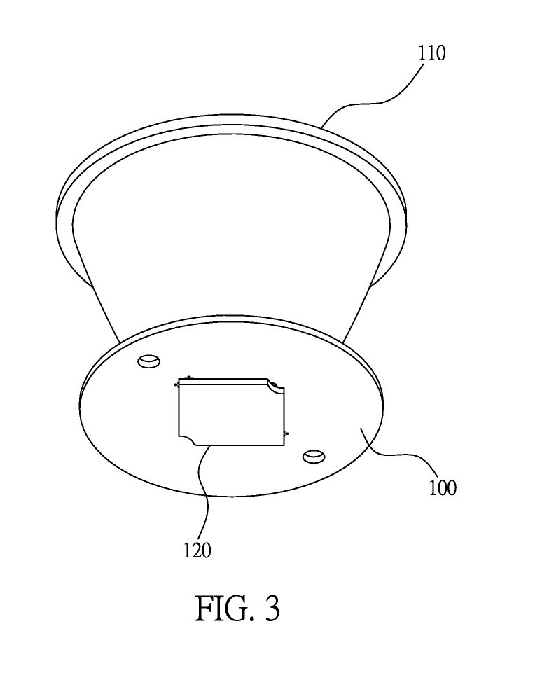

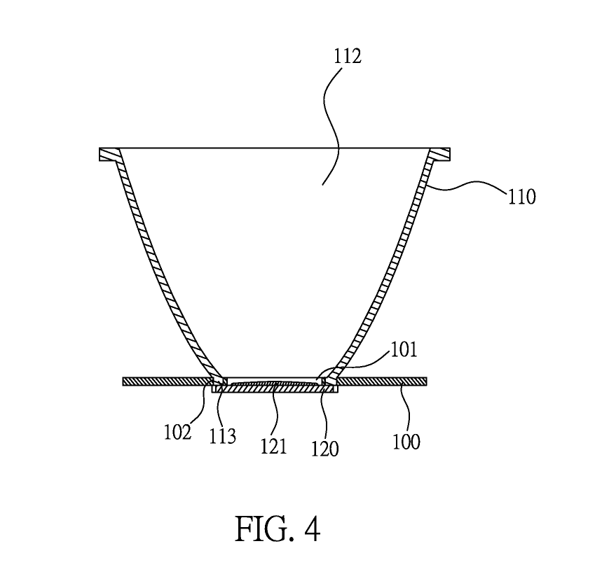

Referring to FIG. 2 and FIG. 3, wherein FIG. 2 is a schematic view illustrating the appearance of the assembled compact LED module of FIG. 1 according to one embodiment of the present invention; FIG. 3 is another schematic view illustrating the appearance of the assembled compact LED module of FIG. 1 according to one embodiment of the present invention; and FIG. 4 is a cross sectional view illustrating the assembled compact LED module of FIG. 1 according to one embodiment of the present invention. As shown from FIG. 2 to FIG. 4, there is no mechanical interference generated when the reflection cup 110 is combined with the circuit substrate 100. Accordingly, the present invention enables the assembly procedure of LED module to be simplified.

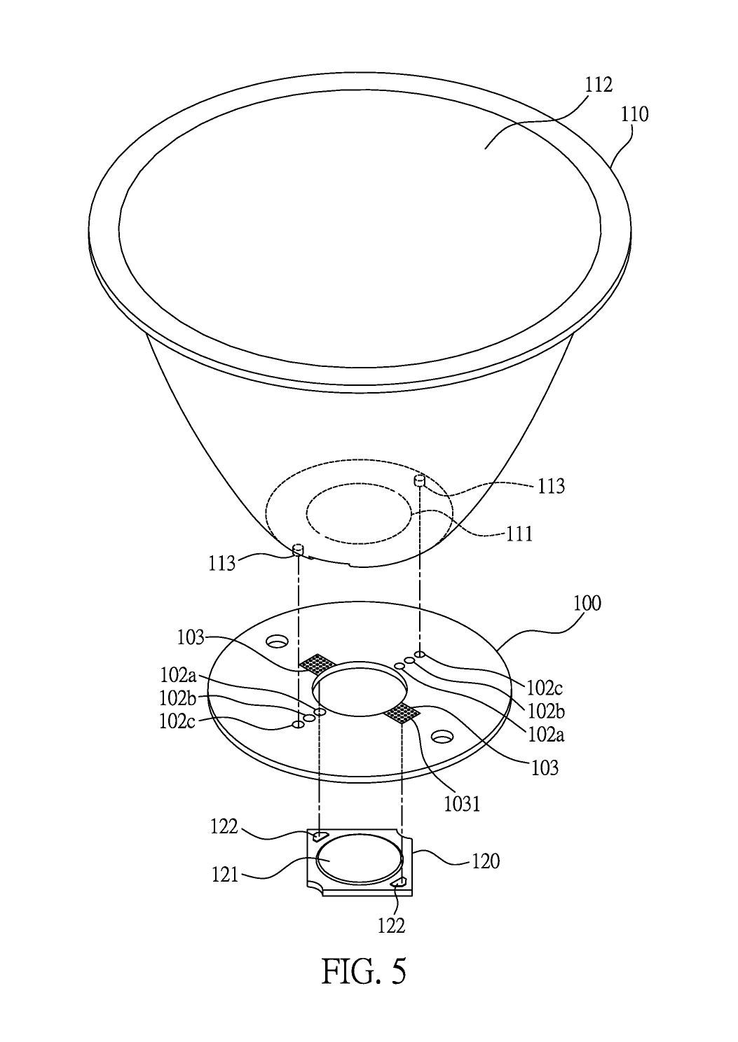

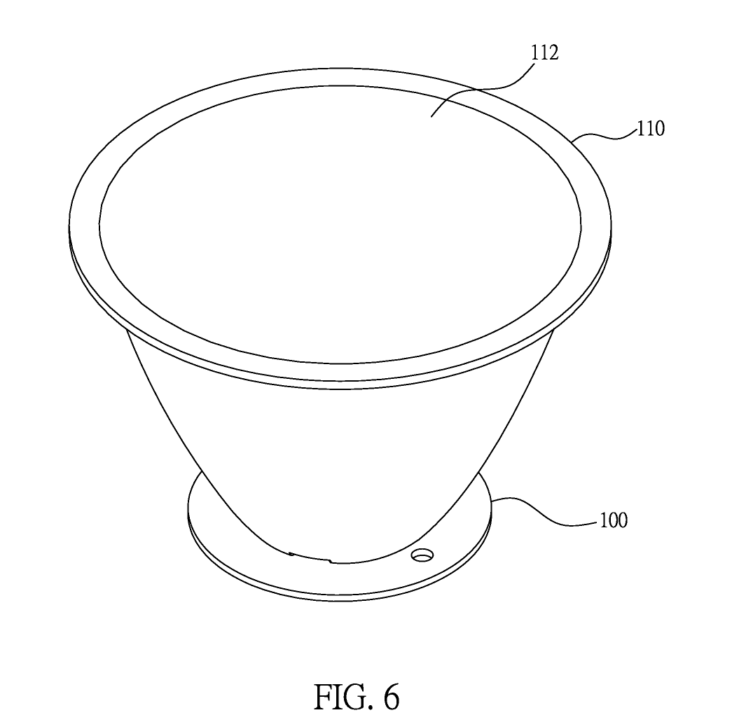

Moreover, through increasing the amount of combination holes 102 formed on the circuit substrate 100, the LED module provided by the present invention is enabled to support reflection cups in various sizes. Referring to FIG. 5 and FIG. 6, wherein FIG. 5 is an exploded view illustrating the compact LED module according to another embodiment of the present invention; and FIG. 6 is a schematic view illustrating the assembly of the compact LED module of FIG. 5 according to another embodiment of the present invention. As shown in FIG. 5, the circuit substrate 100 is formed with a pair of combination holes 102a, a pair of combination holes 102b and a pair of combination holes 102c, wherein a distance is formed between the pair of combination holes 102a is smaller than a distance defined between the pair of combination holes 102b, and the distance defined between the pair of combination holes 102b is smaller than a distance defined between the pair of combination holes 102c; and a distance defined between the pair of combination posts 113 of the reflection cup 110 is matched with the distance defined between the pair of combination holes 102c. In other words, according to this embodiment, the circuit substrate 100 is able to support the reflection cup 110 having a relatively larger size.

Advantages achieved by the present invention are as followings:

1. The compact LED module of the present invention can be assembled through a compact assembling structure, so the mechanical interference caused by the reflection cup can be avoided and the assembly procedure can also be simplified.

2. According to the compact LED module of the present invention, a plurality of combination holes can be formed on a circuit substrate, so reflection cups in various sizes can be supported.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A compact LED module, including:
a circuit substrate, formed with an opening, a pair of combination holes and at least one through via area, wherein said pair of combination holes oppose each other across said opening and each of said through via area is formed with a plurality of through vias;
a reflection cup, formed with a light inlet, a light outlet and a pair of combination posts, wherein said pair of combination posts oppose each other across said light inlet and combined with said pair of combination holes of said circuit substrate, thereby allowing said reflection cup to be fastened on a first surface of said circuit substrate, and said light inlet is aligned with said opening of said circuit substrate; and
a LED unit, installed with a LED light source and formed with at least one soldering area, wherein each of said soldering areas is connected to each of said through via areas of said circuit substrate by utilizing solder, thereby allowing said LED unit to be fastened on a second surface of said circuit substrate, and said LED light source is aligned with said opening of said circuit substrate.

2. The compact LED module as claimed in claim 1, wherein an adhesive layer is further provided between said reflection cup and said circuit substrate for fastening said reflection cup on said first surface of said circuit substrate.

3. The compact LED module as claimed in claim 1, wherein said circuit substrate is installed with a drive circuit.

4. The compact LED module as claimed in claim 1, wherein said circuit substrate is made of an aluminum substrate.

5. The compact LED module as claimed in claim 1, wherein said LED light source of said LED unit includes at least one LED chip for providing a white light or a non-white light.

6. The compact LED module as claimed in claim 1, wherein said LED unit is a DC LED unit.

7. The compact LED module as claimed in claim 1, wherein said LED unit is an AC LED unit.

8. A compact LED module, including:
a circuit substrate, formed with an opening, plural pairs of combination holes and a plurality of through via areas, wherein each pair of said plural pairs of combination holes oppose each other across said opening and have a different distance therebetween, and each of said through via areas is formed with a plurality of through vias;
a reflection cup, formed with a light inlet, a light outlet and a pair of combination posts, wherein said pair of combination posts oppose each other across said light inlet and combined with one pair of said plural pairs of combination holes of said circuit substrate, thereby allowing said reflection cup to be fastened on a first surface of said circuit substrate, and said light inlet is aligned with said opening of said circuit substrate; and
a LED unit, installed with a LED light source and formed with a plurality of soldering areas, wherein each of said soldering areas is connected to each of said through via areas of said circuit substrate by utilizing solder, thereby allowing said LED unit to be fastened on a second surface of said circuit substrate, and said LED light source is aligned with said opening of said circuit substrate.

9. The compact LED module as claimed in claim 8, wherein said LED light source of said LED unit includes at least one LED chip for providing a white light or a non-white light.

10. The compact LED module as claimed in claim 8, wherein said LED unit is a DC LED unit or a AC LED unit.
